(19) United States
(12) Patent Application Publication
(10) Pub. No.: US 2026/0237892 A1
(43) Pub. Date: Aug. 13, 2026

(54) OPTICALLY TRANSPARENT ANTENNA AND ASSOCIATED ANTENNA ARRAY

(71) Applicant: Northrop Grumman Systems Corporation, Falls Church, VA (US)

(72) Inventors: Grant Camden Miars, Detroit, MI (US); Torrence Gue, Los Angeles, CA (US)

(21) Appl. No.: 19/050,383

(22) Filed: Feb. 11, 2025

(51) Int. Cl. H01Q 1/36; H01Q 1/22; H01Q 21/00

(52) U.S. Cl. CPC H01Q 1/364; H01Q 1/22; H01Q 21/00

(57) ABSTRACT

An antenna extending in a lateral direction and a transverse direction orthogonal to the lateral direction includes a ground plane layer, a solar panel layer positioned on the ground plane layer, and an optically transparent electrically conductive layer positioned on the solar panel layer. The optically transparent electrically conductive layer, in turn, is configured to receive or transmit at least one of radio waves or microwaves. As such, at least a portion of the optically transparent electrically conductive layer is aligned with at least a portion of the solar panel layer in the lateral direction and the transverse direction.

### FIELD

The present disclosure generally relates to antennas and, more particularly, to optically transparent antennas and associated antenna arrays.

### BACKGROUND

The size of an antenna is an important design parameter. For example, larger antennas generally have higher directionality and peak gain than smaller antennas. However, larger antennas are generally heavier than smaller antennas. Furthermore, larger antennas may be more expensive to manufacture than smaller antennas.

In certain applications, antenna size can be a particularly critical design constraint. For example, a satellite or spacecraft generally requires a large and powerful antenna to transmit signals to and receive signals from Earth. However, increasing the weight of an antenna (e.g., by making it larger) can dramatically increase the cost of transporting the satellite or spacecraft into space (e.g., due to the need for a larger rocket and increasing fuel consumption). Furthermore, large antennas often need to be deployed/assembled in space, which is expensive. Moreover, such antennas can require significant amounts of power to operate, the availability of which is quite limited on a satellite or spacecraft. Additionally, these trade-offs associated with the size of an antenna can be present in various other applications, such as remotely located radar sites.

Accordingly, an improved antenna would be welcomed in this technology domain.

### SUMMARY

Aspects and advantages of the technology will be set forth in part in the following description, or may be obvious from the description, or may be learned through practice of the technology.

In one aspect, the present disclosure is directed to an antenna extending in a lateral direction and a transverse direction orthogonal to the lateral direction. The antenna includes a ground plane layer, a solar panel layer positioned on the ground plane layer, and an optically transparent electrically conductive layer positioned on the solar panel layer. The optically transparent electrically conductive layer, in turn, is configured to receive or transmit at least one of radio waves or microwaves. As such, at least a portion of the optically transparent electrically conductive layer is aligned with at least a portion of the solar panel layer in the lateral direction and the transverse direction.

In another aspect, the present subject matter is directed to an antenna array extending in a lateral direction and a transverse direction orthogonal to the lateral direction. The arrayed antenna assembly includes a ground plane layer, a solar panel layer positioned on the ground plane layer, and a plurality of antenna elements positioned on the solar panel layer. Each antenna element, in turn, includes an optically transparent electrically conductive layer. Thus, at least a portion of each optically transparent electrically conductive layer is aligned with at least a portion of solar panel layer in the lateral direction and the transverse direction.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology directed to one of ordinary skill in the art, is set forth in the specification, which makes reference to the appended figures, in which:

FIG. 1 is a perspective view of one embodiment of an antenna in accordance with aspects of the present disclosure;

FIG. 2 is a cross-sectional view of the antenna generally taken about Line 2-2 in FIG. 1;

FIG. 3 is a partial, cross-sectional of one embodiment of an optically transparent electrically conductive layer of the antenna in accordance with aspects of the present disclosure; and

FIG. 4 is a partial, cross-sectional of another embodiment of an optically transparent electrically conductive layer of the antenna in accordance with aspects of the present disclosure;

FIG. 5 is a top view of one embodiment of an antenna array in accordance with aspects of the present disclosure; and

FIG. 6 is a cross-sectional view of the antenna array generally taken about Line 6-6 in FIG. 5.

Repeat use of reference characters in the present specification and drawings is intended to represent the same or analogous features or elements of the present technology.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present disclosure is directed to an antenna, such as an optically transparent antenna. Specifically, in several embodiments, the antenna includes a ground plane layer and a solar panel layer positioned on the ground plane layer. The solar panel layer, in turn, includes a plurality of photovoltaic cells for converting sunlight into electricity. Furthermore, the antenna includes an optically transparent electrically conductive layer positioned on the solar panel layer. The optically transparent electrically conductive layer, in turn, is configured to receive and/or transmit radio waves and/or microwaves. In some embodiments, the solar panel layer is positioned between the ground plane layer and the optically transparent electrically conductive layer in the vertical direction. Thus, the solar panel layer forms a dielectric layer between the optically transparent electrically conductive layer and the ground plane layer.

Additionally, at least a portion of the optically transparent electrically conductive layer is aligned with at least a portion of the solar panel layer in the lateral and transverse directions. This, in turn, improves the operation of the antenna. More specifically, the same portion of the surface of the antenna being used to transmit and/or receive radio waves and/or microwave signals can also be used to generate electricity. As such, the surface area of the antenna that can transmit and receive radio waves and/or microwave signals and that can receive sunlight for the generation of electric power is maximized. In this respect, the disclosed antenna can be particularly advantageous in certain applications. For example, when installed on a satellite or spacecraft, the disclosed antenna can both transmit and/or receive radio waves and/or microwave signals and generate electricity via the solar panel layer that can then be used to power the optically transparent electrically conductive layer of the antenna. This, in turn, can reduce the size and weight of the satellite or spacecraft, such as by reducing the need for a separate solar panel.

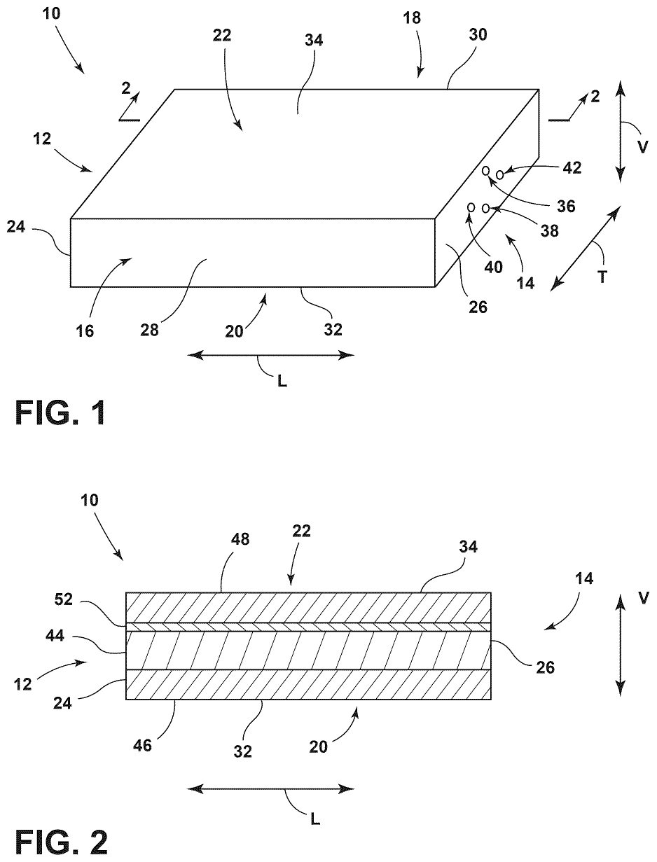

Referring now to the drawings, FIG. 1 is a perspective view of one embodiment of an antenna 10 in accordance with aspects of the present disclosure. As shown, the antenna 10 extends in a lateral direction L from a first side 12 to a second side 14. Furthermore, the antenna 10 extends in a transverse direction T from a forward side 16 to an aft side 18, with the transverse direction T extending orthogonally relative to the lateral direction L. Additionally, the antenna 10 extends in a vertical direction V from a bottom side 20 to a top side 22, with the vertical direction V extending orthogonally relative to the lateral direction L and the transverse direction T.

In the illustrated embodiment, the antenna 10 has a cuboid shape. As such, in the illustrated embodiment, the antenna 10 includes a first side surface 24 positioned on the first side 12 of the antenna 10 and a second side surface 26 positioned on the second side 14 of the antenna 10. Moreover, in the illustrated embodiment, the antenna 10 includes a forward side surface 28 positioned on the forward side 16 of the antenna 10 and an aft side surface 30 positioned on the aft side 18 of the antenna 10. In addition, in the illustrated embodiment, the antenna 10 includes a bottom surface 32 positioned on the bottom side 20 of the antenna 10 and a top surface 34 positioned on the top side 22 of the antenna 10. However, in alternative embodiments, the antenna 10 may have any other suitable shape and, thus, have any other suitable corresponding side surfaces between the bottom surface 32 and the top surface 34 in the vertical direction V.

Furthermore, in several embodiments, the antenna 10 may include first and second feed ports 36, 38 positioned on a side surface of the antenna 10. For example, in the illustrated embodiment, the first and second feed ports 36, 38 are positioned on the second side surface 26 of the antenna 10. However, in other embodiments, the first and second feed ports 36, 38 may be positioned on the first side surface 24, the forward side surface 28, the aft side surface 30, or any other suitable side surface extending between or otherwise positioned between the top surface 34 of the antenna 10 and the bottom surface 32 of the antenna 10. As will described below, the first and second feed ports 36, 38 are configured to be coupled to cables, wires, or other conductors that, in turn, electrically couple the antenna 10 to a transmitter (not shown) and/or receiver (not shown). However, in alternative embodiments, the antenna 10 may include any other suitable number and/or configuration of feed ports.

Additionally, in several embodiments, the antenna 10 may include first and second connectors 40, 42 positioned on a side surface of the antenna 10. For example, in the illustrated embodiment, the first and second connectors 40, 42 are positioned on the second side surface 26 of the antenna 10. However, in other embodiments, the first and second connectors 40, 42 may be positioned on the first side surface 24, the forward side surface 28, the aft side surface 30, or any other suitable side surface extending between or otherwise positioned between the top surface 34 of the antenna 10 and the bottom surface 32 of the antenna 10. As will described below, first and second connectors 40, 42 are configured to be coupled to cables, wires, or other conductors that respectively couple a solar panel layer 44 (FIG. 2) of the antenna 10 to a ground (not shown) and a load (not shown), such as a power grid. However, in alternative embodiments, the antenna 10 may include any other suitable number and/or configuration of connectors.

FIG. 2 is a cross-sectional view of the antenna 10 generally taken about Line 2-2 in FIG. 1. Specifically, in several embodiments, the antenna 10 includes a ground plane layer 46. In general, the ground plane layer 46 is an electrically conducting layer that reflects radio waves or microwaves. Thus, the ground plane layer 46 may be formed from any suitable electrically conductive material. For example, in one embodiment, the ground plane layer 46 may include or otherwise be formed from a solid conductive metal, such as copper, steel, aluminum, and/or the like. Moreover, as shown, the ground plane layer 46 is positioned on the bottom side 20 of the antenna 10. Thus, in some embodiments, the ground plane layer 46 may form the bottom surface 32 of the antenna 10. Additionally, one of the feed ports (e.g., the second feed port 38) may be coupled to the ground plane layer 46 to permit a cable, wire, or conductor to be electrically coupled to the ground plane layer 46.

Furthermore, the antenna 10 includes the solar panel layer 44, which is positioned on the ground plane layer 46. That is, the solar panel layer 44 is positioned above the ground plane layer 46 in the vertical direction V. In general, the solar panel layer 44 includes a plurality of photovoltaic cells configured to convert sunlight into electricity (e.g., DC current). As such, the solar panel layer 44 may have any suitable configuration and/or construction that allows for such functionality. Moreover, the first and second connectors 40, 42 may be coupled to the solar panel layer 44. This, in turn, allows cables, wires, or conductors to be electrically coupled to the solar panel layer 44 to facilitate transmission of the electricity coupled by the solar panel layer 44 to a load.

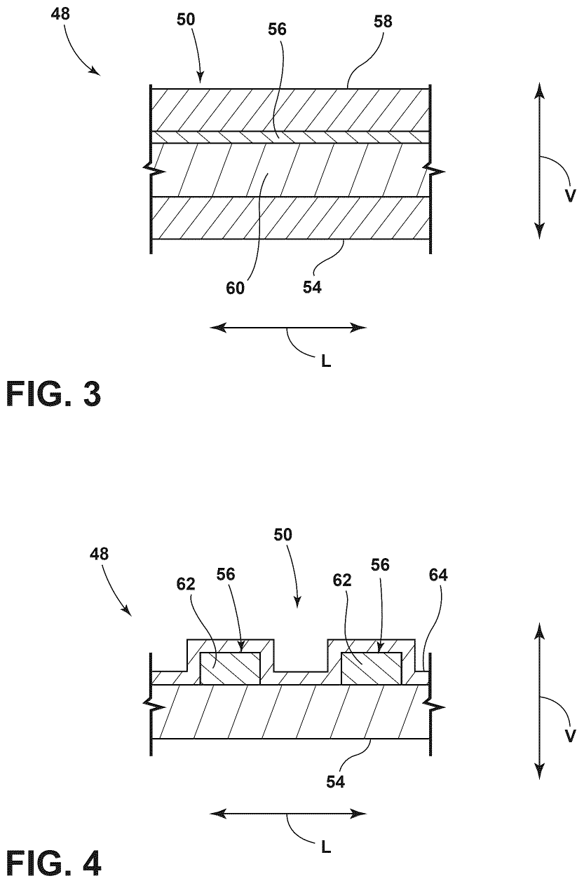

Additionally, the antenna 10 includes an optically transparent electrically conductive layer 48 positioned on the solar panel layer 44. That is, the optically transparent electrically conductive layer 48 is positioned above the ground plane layer 46 and the solar panel layer 44 in the vertical direction V. In general, the optically transparent electrically conductive layer 48 is configured to receive and/or transmit radio waves and/or microwaves. Moreover, as shown, the optically transparent electrically conductive layer 48 is positioned on the top side 22 of the antenna 10. Thus, in some embodiments, the optically transparent electrically conductive layer 48 may form the top surface 34 of the antenna 10. Additionally, one of the feed ports (e.g., the first feed port 36) may be coupled to the optically transparent electrically conductive layer 48 to permit a cable, wire, or conductor to be electrically coupled to the optically transparent electrically conductive layer 48. As will be described below, the optically transparent electrically conductive layer 48 may be configured as or otherwise include an optically transparent electrically conductive film patch 50 (FIG. 3).

Moreover, at least a portion of the optically transparent electrically conductive layer 48 is aligned with at least a portion of the solar panel layer 44 in the lateral and transverse directions L, T. That is, at least a portion of the optically transparent electrically conductive layer 48 is positioned over at least a portion of the solar panel layer 44. Thus, the same portion of the top surface 34 of the antenna 10 being used to transmit and/or receive radio wave and/or microwave signals can also be used to receive absorb sunlight for the generation of electricity. As such, the surface area of the antenna 10 that can transmit and/or receive radio waves and/or microwave signals and that can receive sunlight is maximized. In this respect, the disclosed antenna 10 can be particularly advantageous in certain applications. For example, when installed on a satellite or spacecraft, the antenna 10 can transmit and/or receive radio wave and/or microwave signals and generate electricity via the solar panel layer 44 that can then be used to power the antenna 10. This, in turn, can reduce the size and weight of the satellite or spacecraft, such as by reducing the need for a separate solar panel.

As shown, in several embodiments, the solar panel layer 44 is positioned between the ground plane layer 46 and the optically transparent electrically conductive layer 48 in the vertical direction V. Thus, the solar panel layer 44 forms a dielectric layer between the optically transparent electrically conductive layer 48 and the ground plane layer 46. This, in turn, facilitates the radio wave and/or microwave transmitting and/or receiving functionality of the antenna 10.

The optically transparent electrically conductive layer 48 may be coupled to the solar panel layer 44 in any suitable manner. For example, an optically transparent adhesive layer 52 may couple the optically transparent electrically conductive layer 48 to the solar panel layer 44. Alternatively, the optically transparent electrically conductive layer 48 may couple to the solar panel layer 44 via any suitable fasteners, such as via screws driven in the vertical direction V through both transparent electrically conductive layer 48 and the solar panel layer 44.

FIG. 3 is a partial, cross-sectional of one embodiment of the optically transparent electrically conductive layer 48 and, more specifically, the optically transparent electrically conductive film patch 50 in accordance with aspects of the present disclosure. As shown, the optically transparent electrically conductive film patch 50 includes a polymeric substrate 54 and a metallic layer 56 positioned on the polymeric substrate 54. That is, the metallic layer 56 is positioned above the polymeric substrate 54 in the vertical direction V. Thus, the polymeric substrate 54 supports the metallic layer 56 during and after the deposition or installation of the metallic layer 56 on the antenna 10.

The metallic layer 56 may be or otherwise include any suitable metallic material. For example, in some embodiments, the metallic layer 56 includes or is otherwise formed from a solid conductive metal, such as copper, steel, aluminum, and/or the like. In other embodiments, the metallic layer 56 includes or is otherwise formed from a transparent conductive oxide, such as indium tin oxide, aluminum zinc oxide, zinc oxide, and/or the like.

Additionally, the metallic layer 56 may be deposited or otherwise formed in any suitable manner. For example, in some embodiments, the metallic layer 56 may be formed from a sintered metal ink, silver nanowires, or carbon nanotubes.

In some embodiments, the optically transparent electrically conductive film patch 50 includes a low passive intermodulation (PIM) solderable layer 58 positioned on the metallic layer 56. That is, the low PIM solderable layer 58 is positioned above the metallic layer 56 in the vertical direction V. The low PIM solderable layer 58, in turn, minimizes or otherwise reduces the generation PIM or other unwanted signals, thereby improving the performance of the antenna 10.

Additionally, in some embodiments, the optically transparent electrically conductive film patch 50 may include an adhesion layer 60 positioned between the polymeric substrate 54 and the metallic layer 56 in the vertical direction V. That is, the adhesion layer 60 is positioned above the polymeric substrate 54 and below the metallic layer 56 in the vertical direction V. The adhesion layer 60, in turn, adheres or otherwise couples the metallic layer 56 to the polymeric substrate 54.

FIG. 4 is a partial, cross-sectional of another embodiment of the optically transparent electrically conductive layer 48 and, more specifically, the optically transparent electrically conductive film patch 50 in accordance with aspects of the present disclosure. Like the embodiment shown in FIG. 3, the optically transparent electrically conductive film patch 50 of FIG. 4 includes the polymeric substrate 54 and the metallic layer 56 positioned on the polymeric substrate 54. However, in the embodiment shown in FIG. 4, the metallic layer 56 is configured as a metal mesh layer 62. Additionally, in the embodiment shown in FIG. 4, a carbon nanotube ink layer 64 may be deposited on top of the metal mesh layer 62. That is, the carbon nanotube ink layer 64 may be positioned above the metal mesh layer 62 in the vertical direction V. Thus, the metal mesh layer 62 may be positioned between the polymeric substrate 54 and the carbon nanotube ink layer 64 in the vertical direction V.

In alternative embodiments, the metallic layer 56 may be configured as or formed in any other suitable manner.

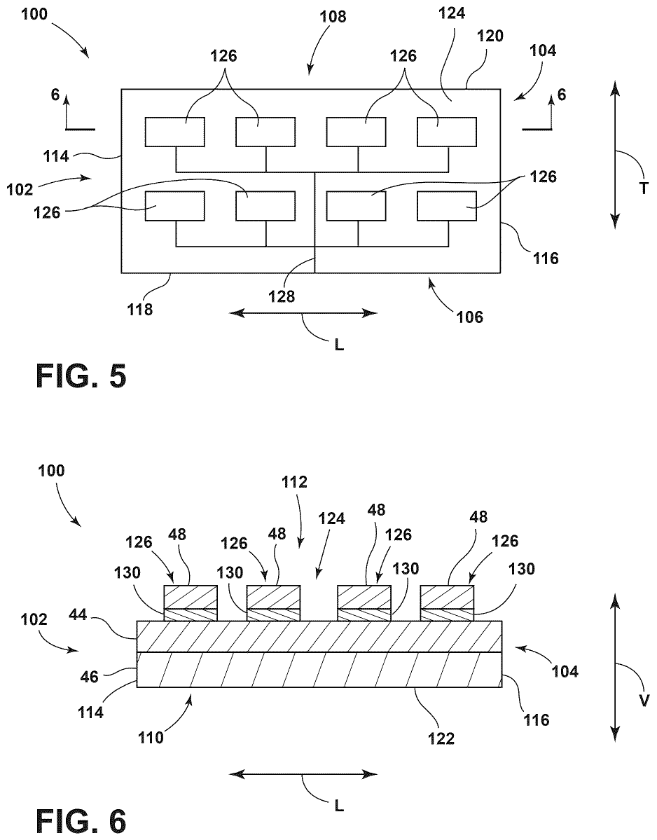

FIG. 5 is a top view of one embodiment of an antenna array 100 in accordance with aspects of the present disclosure. Additionally, FIG. 6 is a cross-sectional view of the antenna array generally taken about Line 6-6 in FIG. 5.

As shown in FIGS. 5 and 6, the antenna array 100 extends in a lateral direction L from a first side 102 to a second side 104. Furthermore, the antenna array 100 extends in a transverse direction T from a forward side 106 to an aft side 108, with the transverse direction T extending orthogonally relative to the lateral direction L. Additionally, the antenna array 100 extends in a vertical direction V from a bottom side 110 to a top side 112, with the vertical direction V extending orthogonally relative to the lateral direction L and the transverse direction T.

In the illustrated embodiment, the antenna array 100 has a cuboid shape. As such, in the illustrated embodiment, the antenna array 100 includes a first side surface 114 positioned on the first side 102 of the antenna array 100 and a second side surface 116 positioned on the second side 104 of the antenna array 100. Moreover, in the illustrated embodiment, the antenna array 100 includes a forward side surface 118 positioned on the forward side 106 of the antenna array 100 and an aft side surface 120 positioned on the aft side 108 of the antenna array 100. In addition, in the illustrated embodiment, the antenna array 100 includes a bottom surface 122 positioned on the bottom side 110 of the antenna array 100 and a top surface 124 positioned on the top side 112 of the antenna array 100. However, in alternative embodiments, the antenna array 100 may have any other suitable shape and, thus, have any other suitable corresponding side surfaces between the bottom surface 122 and the top surface 124 in the vertical direction V.

Like the antenna 10 described above, the antenna array 100 includes the ground plane layer 46 and the solar panel layer 44 positioned on the ground plane layer 46.

Furthermore, as shown in FIGS. 5 and 6, the antenna array 100 includes a plurality of antenna elements 126 positioned on the solar panel layer 44. That is, the antenna elements 126 are positioned above the solar panel layer 44 in the vertical direction V. In this respect, the solar panel layer 44 is positioned between the ground plane layer 46 and each antenna element 126 in the vertical direction V. Thus, the solar panel layer 44 forms a dielectric layer between the antenna elements 126 and the ground plane layer 46. Moreover, the antenna elements 126 are spaced apart from each in the lateral and/or transverse directions L, T on top of the solar panel layer 44. In addition, the antenna elements 126 may be electrically coupled together via a feed line 128, which may electrically couple the antenna elements 126 to a transmitter (not shown) and/or receiver (not shown).

As particularly shown in FIG. 6, each antenna element 126 includes the optically transparent electrically conductive layer 48. In this respect, at least a portion of the optically transparent electrically conductive layer 48 of each antenna element 126 is aligned with at least a portion of the solar panel layer 44 in the lateral and transverse directions L, T. That is, at least a portion of each optically transparent electrically conductive layer 48 is positioned over at least a portion of the solar panel layer 44. Thus, the same portion of the top surface 124 of the antenna array 100 being used to transmit and/or receive radio wave and/or microwave signals can also be used to absorb sunlight for the generation of electricity. As such, the surface area of the antenna array 100 that can transmit and/or receive radio wave and/or microwave signals and that can receive sunlight is maximized.

The optically transparent electrically conductive layer 48 of each antenna element 126 may be coupled to the solar panel layer 44 in any suitable manner. For example, the optically transparent adhesive layer 52 may couple each optically transparent electrically conductive layer 48 to the solar panel layer 44. Alternatively, each optically transparent electrically conductive layer 48 may couple to the solar panel layer 44 via any suitable fasteners, such as via screws driven in the vertical direction V through both the transparent electrically conductive layers 48 and the solar panel layer 44.

This written description uses examples to disclose the technology to enable any person skilled in the art to practice the technology, including making and using any devices or systems and performing any incorporated methods. The patentable scope of the technology is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An antenna extending in a lateral direction and a transverse direction orthogonal to the lateral direction, the antenna comprising:
a ground plane layer;
a solar panel layer positioned on the ground plane layer; and
an optically transparent electrically conductive layer positioned on the solar panel layer, the optically transparent electrically conductive layer configured to receive or transmit at least one of radio waves or microwaves,
wherein at least a portion of the optically transparent electrically conductive layer is aligned with at least a portion of the solar panel layer in the lateral direction and the transverse direction.

2. The antenna of claim 1, wherein:
the antenna further extends in a vertical direction orthogonal to the lateral direction and the transverse direction; and
the solar panel layer is positioned between the ground plane layer and the optically transparent electrically conductive layer in the vertical direction.

3. The antenna of claim 1, further comprising:
an optically transparent adhesive layer coupling the optically transparent electrically conductive layer to the solar panel layer.

4. The antenna of claim 1, wherein the optically transparent electrically conductive layer comprises an optically transparent electrically conductive film patch.

5. The antenna of claim 4, wherein the optically transparent electrically conductive film patch comprises a polymeric substrate and a metallic layer positioned on the polymeric substrate.

6. The antenna of claim 5, wherein the optically transparent electrically conductive film patch comprises a low passive intermodulation (PIM) solderable layer positioned on the metallic layer.

7. The antenna of claim 5, wherein the metallic layer comprises a solid conductive metal.

8. The antenna of claim 5, wherein the metallic layer comprises a metal mesh layer.

9. The antenna of claim 5, wherein the metallic layer comprises a sintered metal ink.

10. The antenna of claim 5, wherein the metallic layer comprises transparent conductive oxide.

11. The antenna of claim 1, wherein the solar panel layer forms a dielectric layer between the optically transparent electrically conductive layer and the ground plane layer.

12. The antenna of claim 1, wherein the ground plane layer comprises solid conductive metal.

13. The antenna of claim 1, further comprising:
a feed port coupled to the optically transparent electrically conductive layer and positioned on a side surface of the antenna extending between a top surface of the antenna formed by the optically transparent electrically conductive layer and a bottom surface of the antenna formed by the ground plane layer in a vertical direction orthogonal to the lateral direction and the transverse direction.

14. An antenna array extending in a lateral direction and a transverse direction orthogonal to the lateral direction, the arrayed antenna assembly comprising:
a ground plane layer;
a solar panel layer positioned on the ground plane layer; and
a plurality of antenna elements positioned on the solar panel layer, each antenna element comprising an optically transparent electrically conductive layer,
wherein at least a portion of each optically transparent electrically conductive layer is aligned with at least a portion of solar panel layer in the lateral direction and the transverse direction.

15. The antenna array of claim 14, wherein:
the arrayed antenna assembly further extends in a vertical direction orthogonal to the lateral direction and the transverse direction; and
the solar panel layer is positioned between the ground plane layer and each antenna element in the vertical direction.

16. The antenna array of claim 14, wherein each antenna element further comprises:
an optically transparent adhesive coupling each optically transparent electrically conductive layer to the solar panel layer.

17. The antenna array of claim 14, wherein each optically transparent electrically conductive layer comprises an optically transparent electrically conductive film patch.

18. The antenna array of claim 17, wherein each optically transparent electrically conductive film patch comprises a polymeric substrate and a metallic layer positioned on the polymeric substrate.

19. The antenna array of claim 18, wherein the metallic layer comprises solid conductive metal.

20. The antenna array of claim 14, wherein the solar panel layer forms a dielectric layer between each antenna element and the ground plane layer.
